(19) United States
(12) Patent Application Publication
(10) Pub. No.: US 2024/0250388 A1
(43) Pub. Date: Jul. 25, 2024

(54) METHOD FOR CONDITIONING A BATTERY

(71) Applicant: NUMBAT GMBH, Kempten (Allgäu) (DE)

(72) Inventor: Maximilian Wegener, Kempten (Allgäu) (DE)

(21) Appl. No.: 18/274,817

(22) PCT Filed: Jan. 19, 2022
(86) PCT No.: PCT/DE2022/100050

§ 371 Date: Jan. 22, 2024

(30) Foreign Application Priority Data
Feb. 2, 2021 (DE) 10 2021 102 316.5

(51) Int. Cl. H01M 50/516; H01M 10/42

(52) U.S. Cl. CPC H01M 50/516; H01M 10/42; H01M 2220/20

(57) ABSTRACT

The invention relates to a method for conditioning a battery (1) comprising at least two battery cells (2-10) which are electrically connected to a first connecting unit (12, 14), and to a battery (1) having a battery cell (2-10) and a replacement battery cell (30). In particular, the invention relates to a method for conditioning a battery (1) having at least two battery cells (2-10) which are electrically connected to a first connecting unit (12, 14), wherein electrically conductive contact connections (16) act between the first connecting unit (12, 14) and the battery cells (2-10), comprising the steps of: detaching the first connecting unit (12, 14) from the battery cells (2-10) by removing the contact connections (16); replacing at least one battery cell (2-10) of the battery (1) with a replacement battery cell (30); and electrically contacting the battery cell (2-10) or the battery cells (2-10) and the at least one replacement battery cell (30), removing the contact connections (16) using a detaching manufacturing process.

The invention relates to a method for conditioning a battery having at least two battery cells electrically connected to a first connecting unit, and a battery having a battery cell and a replacement battery cell.

Batteries are used in a plurality of technical products. The applications of batteries have become more diverse in the past. For example, a plurality of conventional drives are currently being replaced by electrically powered drives whose energy source is often a battery. Furthermore, wired power supplies are being replaced by integrated batteries, as this advances the ongoing miniaturization of technical products and improves convenience for a user.

However, the resulting leap in the number of batteries in use means that efficient use of these batteries and the components contained in the batteries is required in order to increase the economic efficiency of battery use on the one hand and to keep negative ecological impacts to a minimum on the other.

Despite some marketable approaches, only a few methods for conditioning batteries are available. Batteries usually comprise a plurality of battery cells that are electrically contacted with each other. This contacting can be done, for example, with a bus bar. When conditioning a battery, the bus bar is removed from the battery cells by applying mechanical force. In this process, the battery cells can be damaged or the poles of the battery cells are in a non-reusable state. As a result, a plurality of batteries and battery cells are not reused and must be disposed of.

Efficient approaches for conditioning batteries do not currently exist, especially since separating battery cells from each other is only possible with a great deal of technical effort and/or by damaging them. For example, the application of laser-based methods has shown that, although this can lead to satisfactory results, the separation of a battery cell from a bus bar takes up to several days and is therefore not a method that can be applied in practice.

It is therefore an objective of the invention to provide a method for conditioning a battery and a battery that reduces or eliminates one or more of the aforementioned disadvantages. In particular, it is an objective of the invention to provide a solution that enables cost-effective and/or ecologically sustainable conditioning of batteries. At least, it is an objective of the invention to provide an alternative method and/or an alternative battery.

According to a first aspect, this objective is solved by a method for conditioning a battery having at least two battery cells electrically connected to a first connecting unit, electrically conductive contact connections acting between the first connecting unit and the battery cells, comprising the steps of: detaching the first connecting unit from the battery cells by replacing the contact connections, replacing at least one battery cell of the battery with a replacement battery cell, and electrically contacting the battery cell or the battery cells and the at least one replacement battery cell, wherein the removing of the contact connections is performed with a detaching manufacturing process.

The invention is based on the recognition that the success of battery-powered systems depends largely on the ability to use batteries efficiently. Currently, for example, batteries with a performance of less than 80% are removed from vehicles and are generally not subsequently reused. Therefore, a high number of batteries that cannot be further used can currently be expected.

The method for conditioning a battery described in the foregoing makes it possible for a battery that has already been used to be conditioned in such a way that it can be used for subsequent applications, for example for electricity storage or for vehicle batteries with lower requirements.

Furthermore, the inventors have found that the method for conditioning a battery is a reproducible method. The method can be used for a wide variety of batteries without having to pay attention to specific characteristics of the first connecting unit or the poles of the individual battery cells. In particular, the method can be applied to those batteries whose specific manufacturing process is unknown. This is particularly necessary because the battery conditioning company is regularly not the manufacturer of a battery.

In addition, detaching manufacturing processes bring about a defined mechanical influence on the battery cells and on the first connecting unit, so that these can be taken into account in the electrical contacting of the battery cell or battery cells and the at least one replacement battery cell in an advantageous manner.

The method is further characterized by a high process speed. Furthermore, it was found that the method can be used at low cost. In addition, the availability of tools for detaching manufacturing processes is generally considered to be good. As a result, the conditioning of batteries can be carried out industrialized in series and a sustainable use of batteries is made possible.

A battery is basically understood to be a storage unit for storing electrical energy. The battery can be configured as an accumulator, for example. The battery may, for example, be configured to supply a vehicle drive and/or a power storage unit and/or have a capacity of more than 10 kWh, more than 25 kWh, more than 50 kWh and/or more than 75 kWh.

A battery generally comprises a plurality of individual battery cells. The battery cells of a battery may be combined into battery modules such that a battery comprises or includes one, two, or more battery modules. A battery module typically has a capacity of less than 10 kWh, less than 5 kWh, in particular less than 2 kWh. The battery cells may be, for example, electrochemical energy storage devices.

During use of such a battery, defects or wear typically occur in the battery cells, reducing their performance. These battery cells also reduce the performance of the battery. The invention was further based on the knowledge that batteries can be reconditioned by replacing battery cells with reduced performance.

In particular, conditioning of a battery is understood to mean a change in composition with respect to the battery cells. For example, conditioning can lead to an increase in performance, but this is not mandatory. For example, from two batteries with a respective performance of 75%, two conditioned batteries can be provided, one battery having 80% performance and the other 70% performance.

The battery cells are electrically connected to a first connecting unit. The first connecting unit may be, for example, a bus bar and/or a current collector. In particular, the first connecting unit is arranged and configured in such a way that it electrically and/or mechanically connects the at least two battery cells. For this purpose, the first connecting unit preferably has an electrically conductive material or consists of an electrically conductive material.

To ensure an electrical connection between the first connecting unit and the battery cells, electrically conductive contact connections act between the first connecting unit and the battery cells, which can furthermore form a mechanical connection. The electrically conductive contact connections can be configured, for example, by means of a substance-to-substance connection between the battery cells and the first connecting unit in each case. The materially interlocking connection can be configured, for example, by means of a welding spot. In addition, the contact connections can also be configured as an independent contact unit, each of which is connected to the battery cells and the first connecting unit. Complementarily or alternatively, the contact connections can also be part of the first connecting unit and/or the battery cells.

To detach the first connecting unit from the battery cells, the contact connections are removed. Removing the contact connections is performed using a detaching manufacturing process. A detaching manufacturing process is understood in particular as a manufacturing process in which a part is detached from a workpiece, wherein this part may be configured in the form of a chip. A selection of detaching manufacturing processes is contained, for example, in the German standard DIN 8580. Removing the contact connections can result in material removal from the first connecting unit and/or from one, two or more of the battery cells. Removing the contact connections is performed in particular in such a way that the first connecting unit can be detached from the battery cells with little force. In particular, this means that there is substantially no mechanical connection between the first connecting unit and the battery cells.

Further, the method comprises replacing at least one battery cell of the battery with a replacement battery cell. This replacing may comprise, for example, removing one, two or more battery cells and installing replacement battery cells. In particular, it is preferred that a number of replacement battery cells corresponding to the removed battery cells are installed. Further, a lower or higher number of replacement battery cells may be provided compared to the number of removed battery cells.

However, in addition, this step may also include separating the battery cells of the battery and then rearranging the battery cells. Thus, from a battery with n battery cells, n−1 battery cells can also be replaced. The battery reconditioned in this manner may have the same number of, more or fewer battery cells than one, two or more batteries from which the battery cells were removed.

The replacement battery cell may be a new or substantially unused battery cell or a used battery cell. It is preferred that the replacement battery cell has a performance substantially equal to the performance of the remaining battery cell or battery cells. The battery cell or battery cells and the replacement battery cell may be of the same or different construction.

In addition, the method comprises the step of electrically contacting the battery cell or battery cells and the at least one replacement battery cell. As will be explained in more detail below, this electrical contacting can be performed using various methods and, for example, using a connecting unit, in particular a first connecting unit and/or a second connecting unit. During the electrical contacting, contact connections are preferably configured between the battery cell or battery cells and the replacement battery cell and a connecting unit or connecting units, respectively. The contact connections can act on the battery cells or on their poles at the same location as before replacement or at a different location.

A preferred embodiment of the method is characterized in that the contact connections are removed by a material removal at the first connecting unit and/or at the battery cells, in particular at poles of the battery cells. By a material removal at the first connecting unit and/or at the battery cells it is to be understood in particular that a material removal at the contact connections as such can also take place. It is preferably a geometrically determined modification of the first connecting unit and/or the battery cells, in particular of the poles of the battery cells, so that the method has a high process stability and can be carried out in a reproducible manner.

The detaching manufacturing process can be a method with a geometrically determined cutting edge, in particular a milling method and/or a drilling method, and/or a method with a geometrically undetermined cutting edge, in particular a grinding method.

A further preferred embodiment of the method is characterized by the fact that a cutting tool is used for removing the contact connections. A cutting tool is used in particular for cutting with a geometrically determined cutting edge. The cutting tool is preferably a milling tool, which may be configured, for example, as a face milling tool and/or an end milling tool. Furthermore, the cutting tool may be a drilling tool. The drilling tool or the milling tool preferably have a tip angle that is as large as possible, since this ensures a low level of interference with the battery cell. The greater the point angle of the drilling tool or the milling tool, the greater the material removal at the battery cell or at the pole of the battery cell. The tip angle of the milling and/or drilling tool is preferably more than 150°, more than 160°, more than 170° and/or more than 175°.

The use of a cutting tool enables high process stability despite the filigree machining on the battery cells. Thus, compared to conventional methods for removing a connecting unit from battery cells, a particularly low negative impact on the battery cells can be made possible. In addition, cutting tools are generally readily available and this in a wide variety of designs suitable for the application.

A further refinement of the method is characterized in that a feed direction of the cutting tool is aligned substantially orthogonally to a surface of the first connecting unit and/or a pole surface of one of the battery cells.

Substantially orthogonal means in particular that the feed direction deviates less than 20°, less than 10°, less than 5° and/or less than 2.5° from a surface orthogonal to the surface of the first connecting unit and/or the pole surface. In particular, the pole surface is to be understood as a surface of a pole of the battery cells. The pole surface may be plane-parallel to a planar extension of the first connecting unit.

In a further preferred embodiment, it is provided that the feed direction of the cutting tool is aligned substantially orthogonally to a planar extension of the first connecting unit. In an advantageous manner, this embodiment variant enables targeted removing of the contact connection with little influence on the first connecting unit and/or the battery cell.

A further preferred further embodiment of the method is characterized in that the contact connections each act in a contact section and the cutting tool has a tool diameter which is greater than a main extension direction of the contact section.

The contact sections are each located in particular between one of the battery cells and the first connecting unit. A respective contact connection acts between a battery cell and the first connecting unit. The contact section is to be understood in particular as the section in which a battery cell is electrically and/or mechanically connected to the first connecting unit. This may be, for example, a welding section. The main extension direction of the contact section is the direction in which the contact section extends with its greatest extension, for example the greatest extension of a weld.

The main extension direction preferably extends in a plane with the planar extension of the first connecting unit and/or the pole surface of the battery cell. If the tool diameter is configured larger than the main extension direction of the contact section, a contact connection can be removed with only one feed motion. Thus, the repeated back and forth movement of the cutting tool is avoided. As a result, the method can be carried out quickly and the associated effort is low. In addition, it is possible to automate the method in a particularly advantageous manner, so that the application of the method in series production is made possible.

In a further preferred embodiment of the method, it is provided that the method comprises the step of: Checking the performance of the battery cells. The checking of the performance of the battery cells can be, for example, a voltage measurement and/or a measurement of the capacity. In particular, this may be done with a resistance and/or impedance measurement. Preferably, checking the performance is done before replacing at least one battery cell.

Checking the performance of the battery cells enables battery cells with similar performance to be installed in a battery, thus enabling particularly efficient use of the individual battery cells. The efficient use results, among other things, from the fact that the weakest battery cell often defines the performance of the battery, and thus the use of battery cells with similar performance enables particularly efficient use of the battery cells.

In a further preferred embodiment of the method, it is provided that the method comprises the step of: Categorizing the checked battery cells into at least two performance categories based on a result of the checking.

A result of checking may comprise one, two or more measurement results. It is preferred that a predefined threshold value for the performance, in particular a resistance and/or an impedance, is used for categorizing. It is further preferred that the performance is a State of Health value, such as 80%.

Furthermore, it may be preferred that the battery cell for a first and/or second application is categorized when the threshold value is exceeded and for a third application when the threshold value is not reached. Battery cells for a second application may have a higher performance than batteries intended for a third application. For example, the threshold value of performance may be 70%. For example, the first application may involve use of the battery cell in a first battery life cycle, particularly for a vehicle battery. The second application may concern, for example, the use of the battery cell in a second battery life cycle, in particular for a vehicle battery and/or a power storage device. The third application may, for example, concern the use of the battery cell in a third battery life cycle, in particular for a power storage device. Categorization of the battery cells being checked enables a method suitable for series production for conditioning batteries of different performance.

In a further preferred embodiment of the method, it is provided that the electrically contacting of the battery cell or battery cells and the at least one replacement battery cell is performed with a connecting unit.

The connecting unit may be the same first connecting unit to which the battery cells were already connected in the initial configuration. Furthermore, the connecting unit may be another same first connecting unit, in particular a new first connecting unit. Furthermore, the connecting unit may be a second connecting unit different from the first connecting unit.

Using the same first connecting unit has the advantage of providing particularly resource-efficient batteries, since the first connecting unit is reused. Furthermore, an opening created by the detaching manufacturing process at the first connecting unit can be used in an advantageous insulating manner. The use of another first connecting unit may provide optimal connectivity between the at least one replacement battery cell and the battery cell or cells. The use of a second connecting unit may enable an optimal adaptability to the reconfiguration from the at least one replacement battery cell and the battery cell or battery cells, for example as will be shown further below, with a special geometry.

A further preferred embodiment of the method is characterized in that contacting sections of the second connecting unit are configured convex on a contact side facing the battery cells. It is preferred that the convex contacting sections are configured in a shell-shaped manner. The contacting sections of the second connecting unit are in particular those sections or regions of the second connecting unit within which contact connections are configured with the battery cells or the at least one replacement battery cell. These are provided, for example, in such a way that a weld is configured at them.

Shell-shaped can mean, for example, hemispherical, oval and/or angular. The convex contacting sections can be configured, for example, as troughs or as embossing. In an advantageous manner, this results in a better geometrical adaptation of the connecting unit to the battery cells, which can thus be more easily connected to the connecting unit. Because of this, less effort is required for electrical contacting.

According to a further preferred embodiment of the method, it is provided that the electrical contacting of the battery cell or battery cells and the at least one replacement battery cell is carried out using a welding method and/or a soldering method. Furthermore, the electrical contacting may be performed with screws and/or clamps. The contacting may be, for example, the arrangement of a connecting unit, in particular the first and/or the second connecting unit, and a subsequent welding or soldering of this connecting unit to the battery cell(s) and the at least one replacement battery cell. The connection by means of a welding method or a soldering method enables an advantageous connection for electrically contacting as well as a high reproducibility of the method.

According to a further preferred embodiment of the method, it is provided that, before the first connecting unit is detached, the contact connections act in each case in a first pole section of the battery cell or in first pole sections of the battery cells and/or the battery cell or the battery cells are electrically contacted in such a way that contact connections are configured in a second pole section of the battery cell, which is different from the first pole section, or in second pole sections of the battery cells, which are different from the first pole sections.

The pole sections are sections of the pole of the battery cell. The second pole section is different from the first pole section, the second pole section preferably being located adjacent to the first pole section. Preferably, the second pole section is located adjacent to the first pole section. In particular, it is preferred that the first pole section is disposed adjacent a first lateral end of the pole and the second pole section is disposed adjacent a second end of the pole different from the first end

The first pole section may further preferably be centrally located on the pole, such that a second pole section is located on each side of the first pole section. It is particularly preferred that the second pole section is located in an area adjacent to a lateral end of the pole, and further preferably adjacent to the first pole section. Thus, a better connectivity of the connecting unit with the battery cell or battery cells and the replacement battery cell is obtained, so that the method has a better automatability and, moreover, a better reproducibility.

According to a further aspect, the above-mentioned objective is detaching by a battery comprising a battery cell and a replacement battery cell, which are electrically connected to a connecting unit, wherein electrically conductive contact connections act between the connecting unit and the battery cell as well as between the connecting unit and the replacement battery cell, wherein preferably the battery is produced by a method according to one of the embodiments named in the foregoing.

In particular, the battery comprises at least one battery cell and/or at least one replacement battery cell. Preferably, the battery comprises two or more battery cells and/or two or more replacement battery cells.

The connecting unit may be a first connecting unit and/or second connecting unit described in the preceding. The battery described in the preceding is characterized by a higher performance and a higher efficiency. In particular, this higher efficiency relates to a better utilization of the available performance capabilities of battery cells. The replacement battery cell is preferably analogous to the battery cell. The replacement battery cell is in particular such a battery cell which was not included in the new production of the battery and/or a battery cell inserted subsequently.

According to a preferred embodiment of the battery, it is provided that the replacement battery cell has a higher performance than the battery cell, in particular the removed battery cell. Furthermore, it is preferred that the replacement battery cell is substantially unused when installed in the battery. Furthermore, the replacement battery cell may be a used battery cell. For example, the replacement battery cell may be a categorized battery cell as described previously.

A preferred embodiment of the battery is characterized in that the battery cell and/or the replacement battery cell each have a first pole section and a second pole section different from the first pole section, wherein the first pole section of the battery cell had a contact connection before removing it, and/or the contact connections between the battery cell and the connecting unit and/or between the replacement battery cell and the connecting unit act in the second pole section. In particular, the pole sections are to be understood as different regions of the pole of the battery cell and/or the replacement battery cell. The pole sections may also be understood as regions for contacting. This embodiment has the advantage that a good connection can be established between the connecting unit and the battery cell or the replacement battery cell.

A further preferred embodiment of the battery is characterized by the fact that the connecting unit has convexly configured contacting sections.

For further advantages, embodiment variants and embodiment details of the further aspects and their possible further embodiments, reference is also made to the description given previously regarding the corresponding features and further embodiments of the method.

Preferred embodiments are explained by way of example with reference to the accompanying figures. They show:

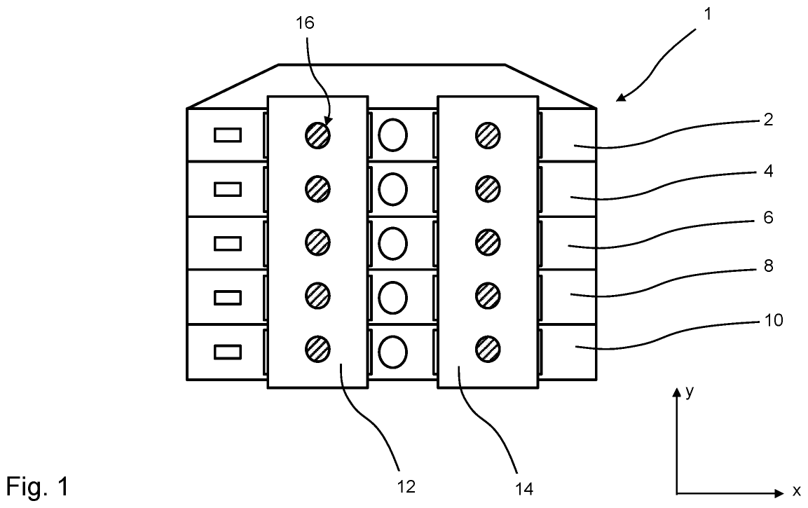

FIG. 1: a schematic, three-dimensional view of an exemplary embodiment of a battery;

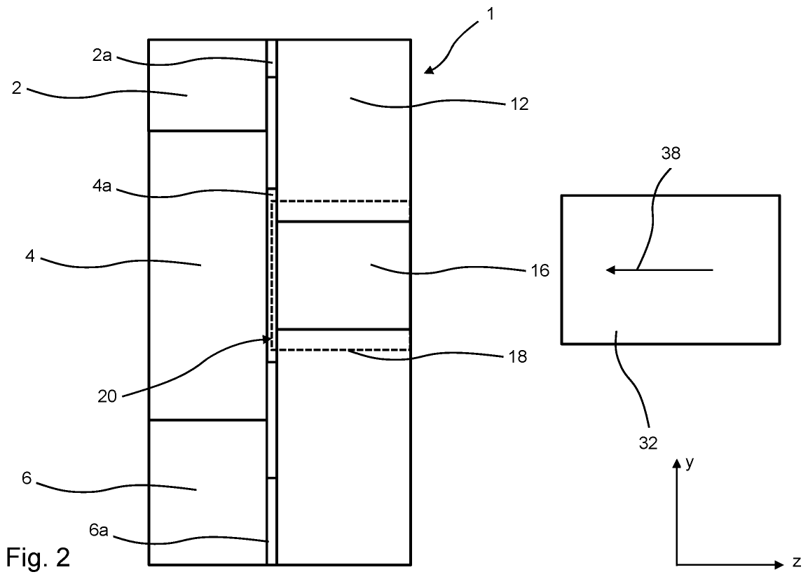

FIG. 2: a schematic, two-dimensional detailed view of the battery;

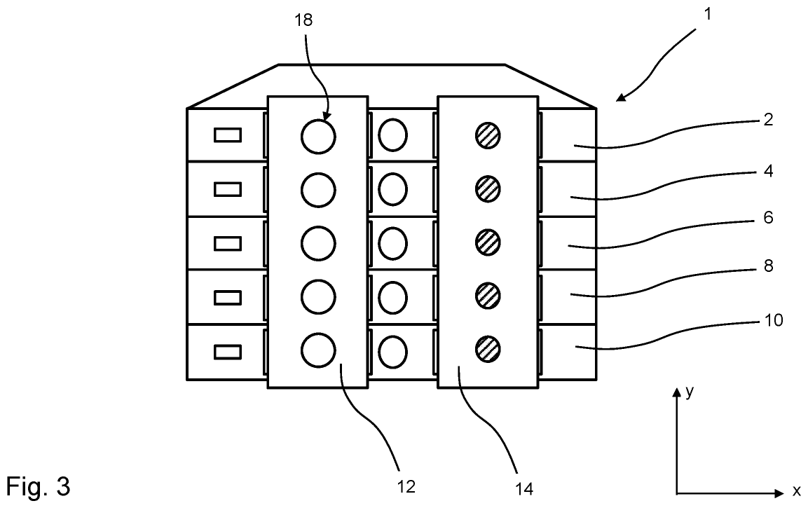

FIG. 3: a schematic, three-dimensional view of the battery after application of a sub-step of the method;

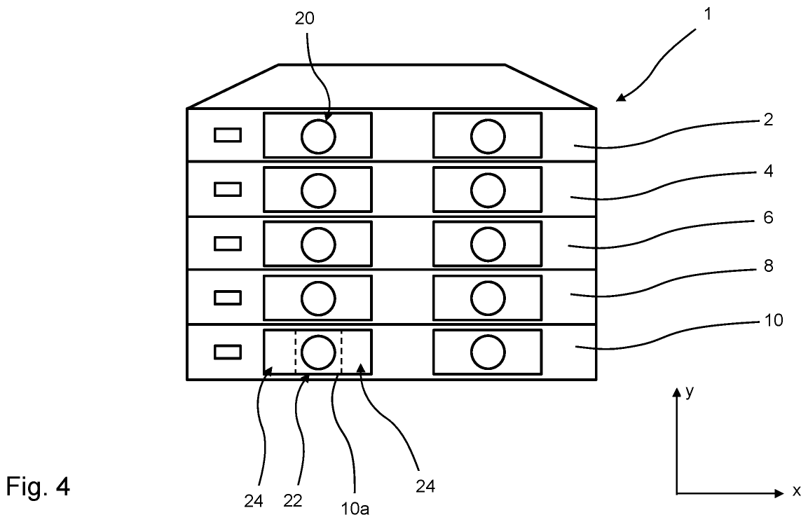

FIG. 4: a schematic, three-dimensional view of the battery after application of a sub-step of the method;

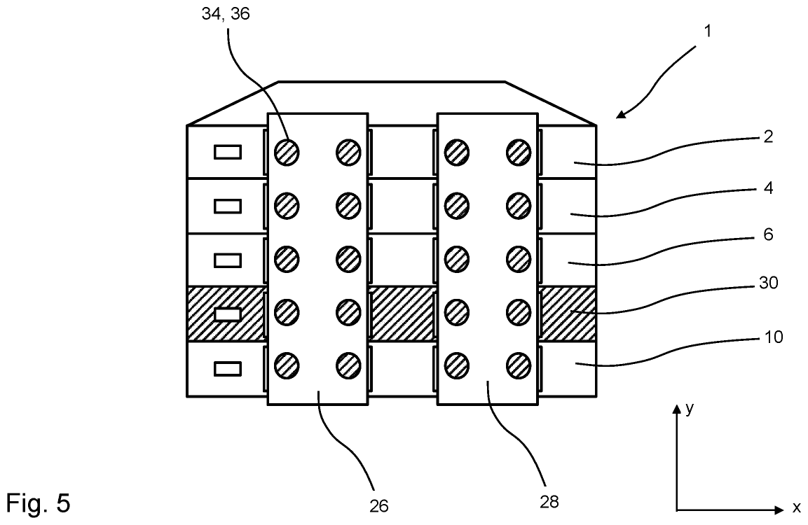

FIG. 5: a schematic, three-dimensional view of the battery of FIG. 1 with a replacement cell and second connecting units;

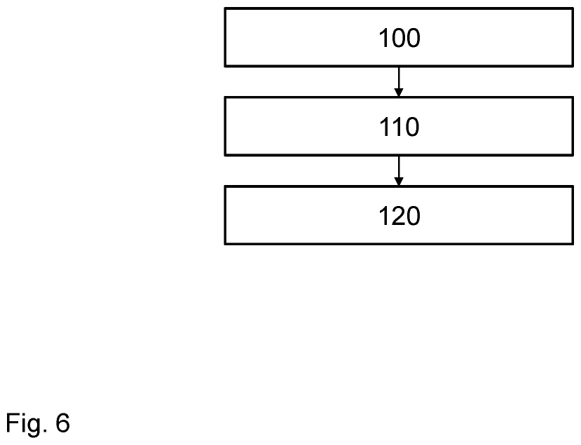

FIG. 6: a schematic method; and

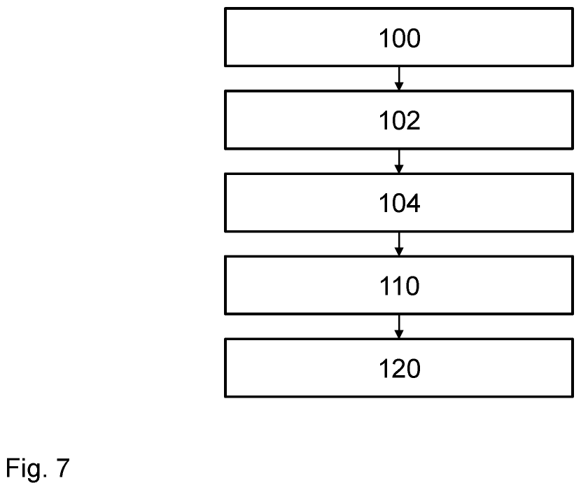

FIG. 7: a further schematic method.

In the figures, identical or substantially functionally identical or similar elements are designated by the same reference signs.

FIG. 1 shows a battery 1 with battery cells 2, 4, 6, 8, 10. The battery cells 2-10 are electrically connected to two first connecting units 12, 14. Electrically conductive contact connections 16 act between the first connecting units 12, 14 and the battery cells 2-10, whereby only the contact connection of the left first connecting unit 12 with the battery cell 2 is provided with the reference sign 16. The other contact connections are constructed in the same way.

FIG. 2 shows a sectional view of the battery 1, with only a section being shown here. In particular, the contact connection 16 between the first connecting unit 12 and the battery cell 4 is shown here, the connecting unit 12 and the battery cell 4 being coupled to one another by means of the pole 4a of the battery cell 4. The contact connection 16 connects the first connecting unit 12 to the battery cell 4. The contact connection 16 may be, for example, a weld. For conditioning the battery 1, it may be necessary for the first connecting unit 12 to be detached from the battery cells 2-10. For this purpose, the contact connections 16 must be removed. According to the previously described method for conditioning a battery 1, the contact connections 16 are removed using a detaching manufacturing process. This is done with a drilling tool 32, the tool diameter of which is larger than a main extension direction of a contact section of the contact connections 16. The contact section extends in the x,y plane.

The feed direction 38 of the cutting tool configured as a drilling tool 32 is oriented orthogonally to a surface of the first connecting unit 12 and to a pole surface of the pole 4a and the battery cell 4, respectively, namely in the z-direction. By drilling the hole or opening 18, which is shown here as a dashed line, with the drilling tool 32, the contact connection 16 is removed. This creates on the one hand an opening in the first connecting unit 12 and on the other hand a recess 20 in the pole 4a of the battery cell 4. It is preferred that the recess 20 in the pole 4a of the battery cell 4 is as small as possible or is avoided. However, it is usually not possible to avoid it completely due to the point angle of the drilling tool 32.

In FIG. 3 the battery of FIG. 1 is shown, the condition after removing the contact connections 16 being shown here, namely these have been removed and the openings 18 are visible. By removing the contact connections 16, the first connecting unit 12 can now be detached from the battery cells 2-10.

In FIG. 4, the condition of the battery 1 is shown with the first connecting units 12, 14 detached and removed. As a result, only the recesses 20 in the poles 2a, 4a, 6a, 8a, 10a of the battery cells 2-10 are visible.

Exemplarily for the battery cells 2-10, an exemplary structure of the pole 10a is shown on the basis of the battery cell 10. The pole 10a comprises a first pole section 22, which is arranged centrally. The first pole section 22 includes the recess 20. Adjacent to the centrally disposed first pole section 22, the pole 10a further comprises two second pole sections 24, which may also be referred to as lateral pole sections.

FIG. 5 shows the conditioned battery 1. The conditioned battery 1 has the battery cells 2-6, 10 and the replacement battery cell 30. The battery cell 8 has been replaced with the replacement battery cell 30. The battery cells 2-6, 10, 30 are electrically contacted by second connecting units 26, 28. Each pole 2a, 4a, 6a, 10a of the battery cells 2-6, 10, 30 is connected with two contact connections 34 to each of the second connecting units 26, 28. Should the available size of the pole 2a, 4a, 6a, 10a and the first contact connections 16 allow it, the connection can also be made with only one contact connection 34. Furthermore, it can be seen that these contact connections 34 are located within the second pole sections. Each pole 2a, 4a, 6a, 10a may also be connected with a contact connection 34 to each of the second connecting units 26, 28.

The second connecting units 26, 28 have convexly configured geometries on a contact side facing the battery cells 2-6, 10, 30, which are shown as troughs 36. These project into the image plane and can be welded to the poles 10a in a particularly advantageous manner using a welding process.

FIG. 6 shows a schematic method for conditioning a battery 1 having a plurality of battery cells 2-10 which are electrically connected to a first connecting unit 12, 14, electrically conductive contact connections 16 acting between the first connecting unit 12, 14 and the battery cells 2-10.

In the step 100, the first connecting unit 12, 14 is detached from the battery cells 2-10. This detaching is carried out by removing the contact connections 16, this being done using a detaching manufacturing process. For example, a drilling tool 32 may be used for this purpose. Alternatively, a milling tool or an abrasive tool can be used for this purpose, for example.

In step 110, at least one battery cell 2-10 of the battery 1 is replaced by a replacement battery cell 30. For this purpose, the at least one battery cell 2-10 is removed from the battery 1 and the replacement battery cell 30 is inserted into the battery 1.

In step 120, the battery cells 2-10 and the at least one replacement battery cell 30 are electrically contacted. This electrically contacting can be done, for example, with a second connecting unit 26, 28, alternatively also with the or a first connecting unit 12, 14.

FIG. 7 shows a preferred schematic method. In the method, steps 102 and 104 are supplemented compared to the method shown in FIG. 6. In step 102 the performance of the battery cells 2-10 is checked. The performance can be checked, for example, with a resistance and/or impedance measurement. Checking is performed prior to replacing 110.

In step 104, the checked battery cells are categorized into at least two performance categories based on a result of the checking. Preferably, a predefined threshold value for performance, such as a resistance or impedance, is used for categorizing.

In particular, it is preferred that steps 102 and/or 104 are performed prior to step 100. In particular, steps 102 and/or 104 may be performed based on information recorded during use of the batteries.

By the method for conditioning a battery 1 described in the foregoing, a reproducible method for conditioning batteries 1 is provided. This method is applicable to different batteries 1 because this method is to be carried out regardless of the geometry of the poles and the contact connections 16, 34. Tools 32 for detaching manufacturing processes are furthermore readily available, for example the drilling tools 32 described in the foregoing. Furthermore, the drilling tool 32 is used to cause defined damage to the battery cells 2-10 and to the connecting unit 12, 14, so that the process is readily controllable. The method is further characterized by high speed and low cost.

### REFERENCE SIGNS

1 battery
2 battery cell
2a pole
4 battery cell
4a pole
6 battery cell
6a pole
8 battery cell
10 battery cell
10a pole
12 first connecting unit
14 first connecting unit
16 contact connection
18 hole
20 recess
22 first pole section
24 second pole section
26 second connecting unit
28 second connecting unit
30 replacement battery cell
32 drilling tool
34 contact connection
36 well
38 feed direction

1. Method for conditioning a battery (1) having at least two battery cells (2-10) electrically connected to a first connecting unit (12, 14), electrically conductive contact connections (16) acting between the first connecting unit (12, 14) and the battery cells (2-10), comprising the steps of:
detaching the first connecting unit (12, 14) from the battery cells (2-10) by removing the contact connections (16);
replacing at least one battery cell (2-10) of the battery (1) with a replacement battery cell (30); and
electrically contacting the battery cell (2-10) or battery cells (2-10) and the at least one replacement battery cell (30),
wherein removing the contact connections (16) is performed using a detaching manufacturing process.

2. Method according to claim 1, wherein the contact connections (16) are removed by a material removal at the first connecting unit (12, 14) and/or at the battery cells (2-10).

3. Method according to any one of the previous claims, wherein a cutting tool, in particular a milling tool, preferably a face milling tool, and/or a drilling tool (32) is used for removing the contact connections (16).

4. Method according to any one of the previous claims, wherein a feed direction of the cutting tool is oriented substantially orthogonally to a surface of the first connecting unit (12, 14) and/or a pole surface of one of the battery cells (2-10).

5. Method according to any one of the previous claims, wherein the contact connections (16) each act in a contact section between one of the battery cells (2-10) and the first connecting unit (12, 14) and the cutting tool has a tool diameter larger than a main extension direction of the contact section.

6. Method according to any one of the previous claims, comprising the step:
checking the performance of the battery cells (2-10), in particular with a resistance and/or impedance measurement,
wherein preferably the checking is performed before replacing at least one battery cell (2-10).

7. Method according to any one of the previous claims, comprising the step of:
categorizing the checked battery cells (2-10) into at least two performance categories based on a result of the checking,
wherein preferably a predefined threshold value for the performance, in particular a resistance and/or an impedance, is used for categorizing, and
preferably categorizing the battery cell (2-10) for a second application when the threshold value is exceeded and for a third application when the threshold value is not reached.

8. Method according to any one of the previous claims, wherein the electrically contacting of the battery cell (2-10) or battery cells (2-10) and the at least one replacement battery cell (30) is carried out with a connecting unit (12, 14, 26, 28), in particular
with the same first connecting unit (12, 14), and/or
with a further first connecting unit, and/or
with a second connecting unit (26, 28) different from the first connecting unit.

9. Method according to any one of the previous claims, wherein
contacting sections (36) of the second connecting unit (26, 28) are configured convex on a contact side facing the battery cells (2-10), and
preferably the convex contacting sections are configured shell-shaped.

10. Method according to any one of the previous claims, wherein the electrically contacting of the battery cell (2-10) or the battery cells (2-10) and the at least one replacement battery cell (30) is carried out by a welding method and/or a soldering method.

11. Method according to any one of the previous claims, wherein the contact connections (16) act in a first pole section of the battery cell (2-10) or in first pole sections of the battery cells (2-10), respectively, before detaching the first connecting unit (12, 14), and the battery cell (2-10) or the battery cells (2-10) are electrically contacted in such a way that contact connections (34) are configured in a second pole section of the battery cell (2-10), which is different from the first pole section, and in second pole sections of the battery cells (2-10), which are different from the first pole sections, respectively.

12. Battery (1) having a battery cell (2-10) and a replacement battery cell (30), which are electrically connected to a connecting unit (12, 14, 26, 28), electrically conductive contact connections (34) acting between the connecting unit (12, 14, 26, 28) and the battery cell (2-10) and between the connecting unit (12, 14, 26, 28) and the replacement battery cell (30), preferably the battery (1) being produced by a method according to any of the preceding claims 1-11.

13. Battery (1) according to the previous claim 12, wherein the replacement battery cell (30) has a higher performance than the battery cell (2-10).

14. Battery (1) according to any one of the previous claims 12-13, wherein
at least one of the battery cell (2-10) and the replacement battery cell (30) each has a first pole section and a second pole section different from the first pole section, wherein the first pole section of the battery cell (2-10) had a contact connection before removing it, and/or
the contact connections (34) between the battery cell (2-10) and the connecting unit (12, 14, 26, 28) and/or between the replacement battery cell (30) and the connecting unit (12, 14, 26, 28) act in the second pole section.

15. Battery (1) according to any of the previous claims 12-14, wherein the connecting unit (12, 14, 26, 28) comprises convexly configured contacting section.
